(19) United States
(12) Patent Application Publication
(10) Pub. No.: US 2024/0155347 A1
(43) Pub. Date: May 9, 2024

(54) SYSTEMS AND METHODS FOR SECURE USER SESSION AT ENDPOINT DEVICE OVER ACCESS-RESTRICTED CELLULAR NETWORK MANAGED BY AN ENTERPRISE

(71) Applicant: Dell Products, LP, Round Rock, TX (US)

(72) Inventors: Anantha K. Boyapalle, Cedar Park, TX (US); Choi Peng Low, Plano, TX (US); Liam B. Quinn, Austin, TX (US); Vivekanandh Narayanasamy Rajagopalan, Bangalore (IN)

(73) Assignee: Dell Products, LP, Round Rock, TX (US)

(21) Appl. No.: 17/982,943

(22) Filed: Nov. 8, 2022

(51) Int. Cl. H04W 12/30; H04L 9/40

(52) U.S. Cl. CPC H04W 12/35; H04L 63/20

(57) ABSTRACT

A system and method of initiating a secure user session for a managed client information handling system through a restricted access secure cellular wireless wide area network (WWAN) from an information technology (IT) server may comprise receiving security configuration settings for the managed client information handling system including an address of an enterprise identity provider, authorization to access a corporate resource, and identification of trusted internet protocol (IP) addresses, as well as instructions to lock or terminate other wireless access and transmitting a secure access provisioning instruction to a restricted access secure WWAN carrier for provisioning of a restricted access eSIM profile to the managed client information handling system limiting a restricted access secure WWAN wireless link to transceive data between the managed client information handling system and the restricted corporate resource or a trusted IP address.

### FIELD OF THE DISCLOSURE

The present disclosure generally relates to embedded subscriber identification module (eSIM) provisioning. The present disclosure more specifically relates to provisioning access to a managed, endpoint client information handling system for a restricted access cellular wireless wide area (WWAN) network to enable secure wireless connectivity to authorized corporate electronic resources or trusted internet protocol (IP) addresses.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. Further, the information handling system may include an antenna system that allows the information handling system to be operatively coupled to a wireless communication network.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing code instructions of a secure user session initiation system at a managed client information handling system endpoint device according to an embodiment of the present disclosure;

FIG. 2 is a block diagram illustrating an information handling system executing code instructions of a secure user session initiation system at an information technology (IT) management server information handling system according to an embodiment of the present disclosure;

FIG. 3 is a block diagram of a network environment architecture offering plural cellular communication protocol options for a managed client information handling systems providing restricted access secure wide-area wireless access network (WWAN) link according to an embodiment of the present disclosure;

FIG. 4 is a block diagram of execution of a secure user session initiation system to establish a restricted access secure WWAN link connecting enterprise managed client information handling systems as endpoints to secure corporate resources according to an embodiment of the present disclosure; and

FIG. 5 is a flow diagram of describing a method of establishing a secure user session via a restricted access secure WWAN link for a managed client information handling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Embodiments of the present disclosure provide for a system and method of automatically provisioning a managed client information handling system with a restricted access embedded subscriber identification module (eSIM) profile and credentials that allow, for example, a wireless interface device to be operatively connected to a secure or restricted access wireless wide area network (WWAN) using an antenna within the information handling system to further conduct transceiving of data between the managed client information handling system endpoint device and trusted internet protocol (IP) addresses or corporate electronic resources for which the managed client information handling system has been granted access by an information technology (IT) professional of the enterprise. The managed client information handling system may be an endpoint device managed by an enterprise or with a client management service in some embodiments. For example, an enterprise may provide for management of a fleet of managed client information handling systems distributed to employees or deployed to operate any number of business or technical activities. Enterprises may periodically need to refresh, replace, swap, or purchase new systems for the fleet of managed client information handling systems. In many cases, several of the managed client information handling systems may need wireless access including via cellular WWAN access such as to 4G, 5G or other cellular wireless protocols.

Enterprises often require users to access secure enterprise corporate resources, such as data, hardware, or software applications positioned behind a secure firewall of the enterprise via specially secured or “air-gapped” managed client information handling systems that are unable to connect to public or unsecure networks or devices, such as regular access WWANs. Such an air-gapping or secure device procedure may inhibit the ability of the user to inadvertently visit unsecure IP addresses, or for non-secure devices to establish wireless access to the managed client information handling system. Either of these scenarios may present a threat of indirect access the secure enterprise corporate resources via the managed client information handling system. However, this may require a complex process of swapping out user devices or repeatedly provisioning or configuring the same client information handling system with different user credentials and capabilities. In some circumstances, an enterprise user may be unable to access restricted corporate resources with a private-user client information handling system, for example, without repeated and complex methods. In current remote-work environments, this may become burdensome to enterprise users. These repeated and complex methods may further result in complicated tracking of these profiles, devices, and users by an IT management system for the enterprise. Such a process to repeatedly reconfigure and track managed client information handling systems may be burdensome and time consuming. A system is needed that can automate and simplify the ways in which managed client information handling systems access such secure enterprise resources without compromising the security of wireless links established to do so.

The secure user session initiation system operating at an IT management server, in tandem with an agent operating at each managed client information handling system in embodiments described herein addresses these issues by automatically provisioning managed client information handling systems with a restricted access cellular network embedded subscriber identity module (eSIM) credentials for accessing a secure WWAN that only grants access of the authorized managed client information handling system to enterprise corporate resources and trusted IP addresses. This restricted access cellular network eSIM is made available via subscription agreement between a management enterprise and a WWAN service provider to provide a controlled network link or soft gateway via a software layer by the restricted access secure WWAN link. This software layer for a soft gateway may execute via secure user session agent and is the only trusted gateway by an enterprise's restricted corporate resources servers in an embodiment.

The method, in an embodiment, may include receipt of configuration policies for a managed client information handling system from an information technology (IT) administrator, including identification of one or more trusted internet protocol (IP) addresses, operational configuration settings, identification of one or more enterprise corporate resources (e.g., hardware, software applications, or data stored behind a security firewall of the enterprise) to which the user of the client information handling system has been granted access, and other login credentials for the client information handling system. In some embodiments, a private-user client information handling system may have a secure user session agent downloaded for use to access restricted corporate resources. In such an embodiment, the private-user client information handling system may become, in whole or in part, an enterprise managed client information handling system. Such private-user client information handling systems may also be referred to as managed client information handling systems in embodiments described herein. Thus, private-user client information handling systems may be utilized to securely access restricted corporate resources or trusted internet protocol (IP) sites according to various embodiments herein. These policies and configurations then may be associated with identifier data for the managed client information handling system at an IT management server. The client information handling system in various embodiments described herein may attempt access of secure corporate resources via a regular access WWAN wireless link in an embodiment. A secure user session agent operating at the managed client information handling system may detect such an unauthorized attempt to access restricted enterprise corporate resources (e.g., located behind a secure enterprise firewall) via such a regular access wireless link.

The IT management server may receive a notification from the secure user session agent at the managed client information handling system that the client information handling system has attempted restricted access to corporate resources via a regular access WWAN wireless link, including identification of the managed client information handling system, and the secure corporate resource in one embodiment. In embodiments of the present disclosure, this may trigger the IT management server to transmit an instruction to a selected restricted access secure WWAN carrier to provision the client information handling system with a restricted access eSIM credential. A pre-approved or subscribing restricted access secure WWAN carrier may be instructed by the IT management server, for example, to allow a user to access a secure wireless connection to a WWAN network to initiate a secure user sessions for transceiving of data with a secure enterprise corporate resource. A subscription manager-discovery server (SM-DS) for the restricted access secure WWAN carrier may be prompted to automatically transmit a restricted access cellular network eSIM profile to the managed client information handling system. In other embodiments, the restricted access cellular network eSIM profile may have been pre-loaded at the managed client information handling system by the IT management server or an IT administrator.

A regular access WWAN wireless link may be established between the selected restricted access secure WWAN carrier base station and the managed client information handling system by the selected restricted access secure WWAN SM-DS. With this regular access WWAN wireless link, a restricted access cellular network eSIM credential may be downloaded to the embedded universal integrated circuit card (eUICC) memory at the managed client information handling system. Then the provisioned restricted access cellular network eSIM credential for the managed client information handling system may then be enabled with the WWAN carrier.

The secure user session agent operating at the managed client information handling system may direct an enterprise user at the managed client information handling system to access an identity provider server system and provide enterprise user login credentials or other secure access credentials for authentication of the enterprise user. In this way, enterprise networks, data, and other resources may be protected from unauthorized access. This includes unauthorized downloads of designated software or firmware or other firewalled corporate resources. If the managed client information handling system transmits verified login credentials to an enterprise identity server in communication with the IT management server, the secure user session agent may then establish a restricted access secure wireless link with the restricted access secure WWAN carrier using the restricted access cellular network eSIM profile. The managed client information handling system may then transceive data with the secure corporate resources and one or more trusted IP addresses identified within the restricted access cellular network eSIM profile. The endpoint secure user session agent in a embodiments may further terminate the regular access WWAN wireless link to inhibit the client information handling system establishing communication with any non-trusted IP addresses. In such a way, the secure user session initiation system operating at an IT management server, in tandem with an agent operating at each managed client information handling system in an embodiment may automatically provision managed client information handling systems with restricted access cellular network eSIM credentials for accessing a restricted access secure WWAN that only grants access of the authorized managed client information handling system to restricted enterprise corporate resources and trusted IP addresses.

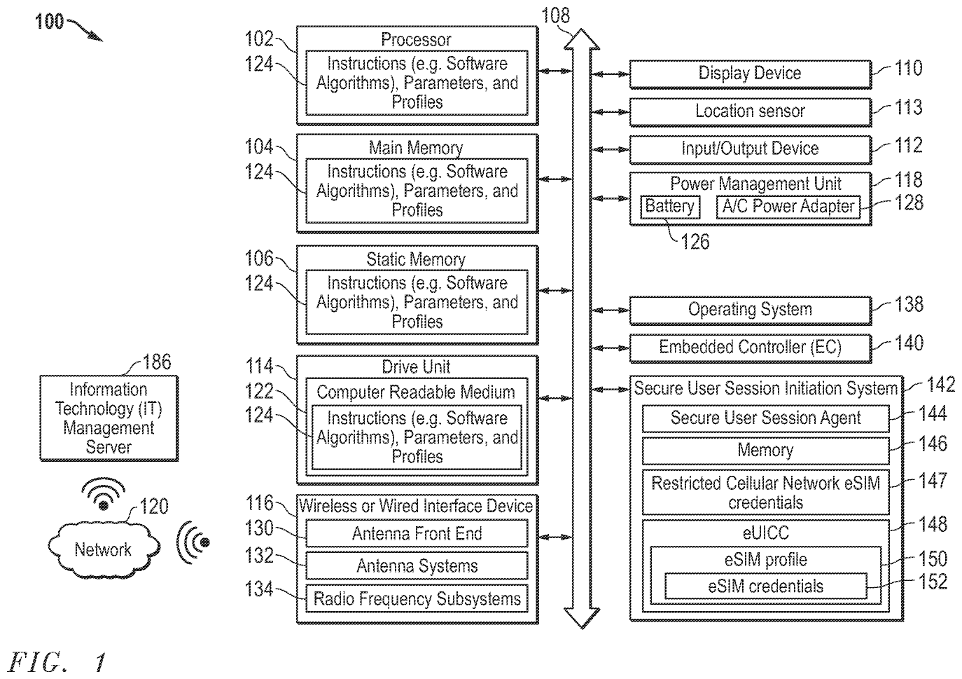

FIG. 1 illustrates an information handling system 100 of a managed client information handling system that may serve as an endpoint device similar to information handling systems that an enterprise user may desire to use to access a restricted enterprise network and secure corporate resources according to several aspects of the present disclosure. In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal trusted device, a web appliance, or any other suitable machine capable of executing a set of instructions (sequential or otherwise) that specify actions to be taken by that machine, and can vary in size, shape, performance, price, and functionality. In example embodiments herein, information handling system 100 may represent any of one or more managed client information handling systems according to embodiments herein. Further, some or all of information handling system 100 may represent a remote IT management server or servers or an enterprise identity server in other various embodiments herein.

In a networked deployment, the information handling system 100 may operate in the capacity of a server or as a client computer in a server-client network environment, or as a peer computer system in a peer-to-peer (or distributed) network environment. In a particular embodiment, the information handling system 100 can be implemented using electronic devices that provide voice, video or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute with one or more hardware processing resources a set, or multiple sets, of instructions to perform one or more computer functions.

The information handling system can include memory (volatile (e.g., random-access memory, etc.), nonvolatile (read-only memory, flash memory etc.) or any combination thereof), one or more hardware processing resources, such as a central processing unit (CPU), a graphics processing unit (GPU), an embedded controller (EC), hardware control logic, a hardware controller or any combination thereof. Additional components of the information handling system 100 can include one or more storage devices, one or more communications ports for communicating with external devices, as well as, various input and output (I/O) devices, such as a keyboard, a mouse, a video/graphic display, or any combination thereof. The information handling system 100 can also include one or more buses operable to transmit communications between the various hardware components. Portions of an information handling system 100 may themselves be considered information handling systems 100.

Information handling system 100 can include devices or modules that embody one or more of the hardware devices or hardware processing resources to execute instructions for the one or more systems and modules described herein, and operates to perform one or more of the methods described herein. The information handling system 100 may execute code instructions 124 that may operate on servers or hardware systems, remote data centers, or on-box in individual client information handling systems according to various embodiments herein. In some embodiments, it is understood any or all portions of code instructions 124 may operate on hardware processing resources at a plurality of information handling systems 100.

The information handling system 100 may include a hardware processor 102 such as a central processing unit (CPU), hardware control logic, hardware controller or some combination of the same. The information handling system 100 may include an EC 140 in some embodiments. Any of the hardware processing resources may operate to execute code that is either firmware or software code. Moreover, the information handling system 100 can include memory such as main memory 104, static memory 106, or memory 146 with computer readable medium 122 storing instructions 124 of the secure user session initiation system 142, a secure user session agent 144, restricted access cellular network eSIM credentials 147 for a restricted access secure WWAN link, and a regular eSIM profile 150 and credentials 152 provisioned for regular WWAN access in embodiments herein. In some embodiments, the computer readable medium 122 storing instructions 124 of the secure user session initiation system 142, a secure user session agent 144, restricted access cellular network eSIM credentials 147 may be preloaded on the information handling system for the restricted access secure WWAN link. The memory or memory storage with computer readable medium 122 may further include drive unit 114 or static memory 106 (volatile (e.g., random-access memory, etc.), nonvolatile (read-only memory, flash memory etc.) or any combination thereof). The information handling system 100 can also include one or more buses 108 operable to transmit communications between the various hardware components such as any combination of various input and output (I/O) devices.

The information handling system 100 may further include a video display 110. The video display 110 in an embodiment may function as a liquid crystal display (LCD), an organic light emitting diode (OLED), a flat panel display, or a solid-state display. Additionally, the information handling system 100 may include an input/output device 112, such as a cursor control device (e.g., mouse, touchpad, or gesture or touch screen input, and a keyboard. The information handling system 100 can also include a disk drive unit 114. A power management unit 118 supplying power to the information handling system 100, via a battery 126 or an alternating current (A/C) power adapter 128 may supply power to one or more components of the information handling system 100, including the hardware processor 102, or other hardware processing resources executing code instructions of the secure user session initiation system 142, the wireless network interface device 116, a static memory 106 or drive unit 114, a, a video display 110, or other components of an information handling system.

The network interface device, shown as wired or wireless interface device 116 can provide connectivity to a network 120, e.g., a wide area network (WAN), a local area network (LAN), wireless local area network (WLAN), a wireless personal area network (WPAN), a wireless wide area network (WWAN), or other networks. Connectivity may be via wired or wireless connection. Wireless interface device 116 may include one or more radio frequency subsystems 134 with transmitter/receiver circuitry, modem circuitry, one or more radio frequency front end circuits, one or more wireless controller circuits, amplifiers, antenna systems 132 and other radio frequency subsystem circuitry 134 for wireless communications via multiple radio access technologies. These radio access technologies may include Wi-Fi communications, Bluetooth, or near-field communication (NFC) technologies. The wireless interface device 116 may operate in accordance with any wireless data communication standards. To communicate with a wireless local area network, standards including IEEE 802.11 WLAN standards, IEEE 802.15 WPAN standards, WWAN such as 3GPP or 3GPP2, or similar wireless standards may be used. In some aspects of the present disclosure, one wireless interface device 116, also referred to as a network interface device may operate according to two or more WWAN wireless links. In an embodiment, restricted access secure WWAN wireless data communications, for example, may be received and transmitted via the antenna system 132 and antenna front end 130 as described in the present disclosure.

The network interface device 116 may operate in accordance with any cellular wireless data communication standards. In embodiments herein, the wireless network interface device 116 may operate with one or more WWAN carriers. For example, the wireless network interface device 116 may operate with one or more WWAN carriers including one or more regular access WWAN carriers operating in the physical location of the managed client information handling system for provisioning of a regular access WWAN eSIM profile 150 on a first, regular access wireless link from the WWAN carrier to the managed client information handling system. The regular access WWAN eSIM profile is transmitted to the managed client information handling system via its network interface device 116 and may be stored in memory 146 of an embedded universal integrated circuit card (eUICC) 148. Further, the wireless network interface device 116 may operate with restricted access secure WWAN carrier to which the enterprise subscribes for the restricted access cellular network eSIM profile credentials 147 used to establish a second, restricted access secure wireless link via the restricted access secure WWAN carrier for transceiving data between the managed client information handling system 100 and secure corporate resources in an embodiment. In this way, provisioning the restricted access cellular network eSIM credentials maintains and enables use of the second, secure access WWAN at the managed client information handling system in embodiments herein to establish a secure user session for accessing secure corporate resources.

Wireless network interface device 116, in an embodiment, may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WWAN standards, which may operate in both licensed and unlicensed spectrums. More specifically, the network interface device 116 in an embodiment may transceive within radio frequencies associated with the 5G New Radio (NR) Frequency Range 1 (FR1) or Frequency Range 2 (FR2), or those associated with 4G LTE and other standards predating the 5G communications standards now emerging. NRFR1 may include radio frequencies below 6 GHz. NRFR2 may include radio frequencies above 6 GHz, made available within the now emerging 5G communications standard. Communications within the WLAN or WWAN may be enabled through the use of either an evolved Node B (eNodeB) executing an evolved packet core of an existing LTE system, or a Next Generation Node B (gNodeB) executing the next generation packet core of the 5G cellular standard. The wireless interface device 116 may also include radio frequency subsystems 134 circuitry used to connect to any combination of macro-cellular wireless connections including 2G, 2.5G, 3G, 4G, 5G or the like from one or more service providers such as a WWAN service provider for access to wireless network 120.

Utilization of radiofrequency communication bands according to some example embodiments of the present disclosure may include bands used with the WLAN standards and WWAN carriers, which may operate in both licensed and unlicensed spectrums. For example, both WLAN and WWAN may use the Unlicensed National Information Infrastructure (U-NII) band which typically operates in the −5 MHz frequency band such as 802.11 a/h/j/n/ac (e.g., center frequencies between 5.170-5.785 GHz). It is understood that any number of available channels may be available under the 5 GHz shared communication frequency band for WLAN. WLAN, in another example, may also operate at a 2.4 GHz band. WWAN may operate in a number of bands, some of which are proprietary but may include a wireless communication frequency band at approximately 2.5 GHz or 5 GHz bands for example. In additional examples, WWAN carrier licensed bands may operate at frequency bands of approximately 700 MHz, 800 MHz, 1900 MHz, or 1700/2100 MHz as well as the NRFR1, NFRF2, bands, and other known bands.

In some embodiments, software, firmware, dedicated hardware implementations such as application specific integrated circuits, programmable logic arrays and other hardware devices can be constructed to implement by executing code instructions of one or more of some systems and methods described herein. Applications that may include the apparatus and systems of various embodiments can broadly include a variety of electronic and computer systems with hardware processing resources executing code instructions in software or firmware. One or more embodiments described herein may implement functions using two or more specific interconnected hardware modules or hardware processing devices with related control and data signals that can be communicated between and through the modules, or as portions of an application-specific integrated circuit. Accordingly, the present system encompasses hardware processing resources executing software or firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionalities as described herein.

The present disclosure contemplates a computer-readable medium that includes instructions, parameters, and profiles 124 or receives and executes instructions, parameters, and profiles 124 responsive to a propagated signal, so that a device connected to a network 120 can communicate voice, video or data over the network 120. Further, the code instructions 124 may be transmitted or received over the network 120 via the network interface device or wireless interface device 116.

The information handling system 100 can include a set of code instructions 124 that when executed by hardware processing resources can be executed to cause the computer system to perform any one or more of the methods or computer-based functions disclosed herein. For example, instructions 124 may execute instructions 124 of the secure user session initiation system 142, a secure user session agent 144, restricted access cellular network eSIM credentials 147 for establishing a restricted access secure WWAN link, and a regular eSIM profile 150 and credentials 152 provisioned for regular access WWAN carrier in embodiments herein, software agents, or other software applications, firmware, or aspects. Various software modules comprising application code instructions 124 may be coordinated by an operating system (OS) 138, and/or via an application programming interface (API). An example operating system may include Windows®, Android®, and other OS types. Example APIs may include Win 32, Core Java API, or Android APIs.

The disk drive unit 114, static memory 106, or memory 146 includes a computer-readable medium 122 in which one or more sets of code instructions 124 such as software or firmware can be embedded. Similarly, main memory 104 and static memory 106 may also contain a computer-readable medium for storage of one or more sets of instructions, parameters, or profiles 124. The disk drive unit 114, static memory 106, or memory 146 may also contain space for data storage. Further, the code instructions 124 may embody one or more of the methods or software systems as described herein. For example, instructions relating to the instructions 124 of the secure user session initiation system 142, a secure user session agent 144, restricted access cellular network eSIM credentials 147 for a restricted access secure WWAN link, and a regular eSIM profile 150 and credentials 152 provisioned for regular WWAN, other software algorithms, processes, and/or methods may be stored here. In a particular embodiment, the instructions, parameters, and profiles 124 may reside completely, or at least partially, within the main memory 104, the static memory 106, memory 146, and/or within the disk drive 114 during execution by the processor 102 or EC 140 of information handling system 100. As explained, some or all of the instructions 124 of the secure user session initiation system 142, a secure user session agent 144, restricted access cellular network eSIM credentials 147 for a restricted access secure WWAN link, and a regular eSIM profile 150 and credentials 152 provisioned for regular WWAN in embodiments herein may be executed locally on a managed client information handling system or remotely at a remote IT management server or servers, SM-DS servers of a carrier, or enterprise identity servers. Further, a remote IT management server information handling system may execute code instructions of an onboarding administrator system executable by hardware processing resources thereon according to various embodiments herein.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The instructions 124 of the secure user session initiation system 142, a secure user session agent 144, restricted access cellular network eSIM credentials 147, and a regular access eSIM profile 150 and credentials 152 may be stored in memory 146, static memory 106, or the drive unit 114 on a computer-readable medium 122 such as a flash memory or magnetic disk in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The information handling system 100 may include code instructions 124 of the secure user session initiation system 142, a secure user session agent 144, restricted access cellular network eSIM credentials 147 for a restricted access secure WWAN link, and a regular eSIM profile 150 and credentials 152 provisioned for regular WWAN access in embodiments herein that may be operably connected to the bus 108. The secure user session initiation system 142 may have computer-readable medium 122 that may also contain space for data storage or access to the data storage. For example, portions of the secure user session initiation system 142 may, according to the present description, include a secure user session agent 144 and restricted access cellular network eSIM profile credentials 147, pre-provisioned or later transmitted for a restricted access secure WWAN link. In embodiments herein, this is done through a subscription manager-discovery server (SM-DS) at an approved restricted access secure WWAN carrier using the restricted access cellular network eSIM profile 147. The secure user session initiation system 142 may also include a memory 146 to maintain, for example, a regular access eSIM profile 150 from a selected regular access WWAN carrier, which may be the same or different from the subscribing restricted access secure WWAN carrier, to allow the managed client information handling system 100 to gain regular WWAN wireless link access.

The secure user session initiation system 142 may also include an embedded universal integrated circuit card (eUICC) 148. The eUICC 148 may, in an embodiment, maintain the regular access eSIM profile 150 with its eSIM credentials 152 at memory 146 when provisioned and enabled from a selected regular access carrier in order to operatively couple the managed client information handling system 100 to a wireless carrier such as a WWAN carrier network. In an embodiment the eUICC 148 may have a separate memory or the same memory may be preloaded with restricted access secure cellular network eSIM credentials 147 for a restricted access secure WWAN link to the IT management server to initiate a secure user session for transceiving data between the managed client information handling system 100 and secure enterprise corporate resources located behind a security firewall. As described herein, a private-user client information handling system may have downloaded a secure user session agent and may be partially or wholly managed by the IT management server as such. In this way, enterprise users may utilize their private client information handling systems as endpoint devices to securely access restricted corporate resources and limited, approved trusted sites via a restricted access secure WWAN link according to embodiments herein.

An IT manager may determine one or more trusted internet protocol (IP) addresses, operational configuration settings, identification of one or more enterprise corporate resources (e.g., hardware, software applications, or data stored behind a security firewall of the enterprise) to which the user of the managed client information handling system 100 has been granted access, and other login credentials for the client information handling system. These policies and configurations then may be associated with identifier data for the managed client information handling system 100 at an IT management server 186. A pre-approved or subscribing restricted access secure WWAN carrier may be instructed by the IT management server 186 in an embodiment to allow a user to, via the wireless interface device 116, access a secure wireless connection to a WWAN network 120 to initiate a secure user sessions for transceiving of data with a secure enterprise corporate resource. The preapproved restricted access secure WWAN carrier may receive indication that the restricted access cellular network eSIM credentials 147 are to be accepted at the SM-DS and that the enterprise user has subscribed to that restricted access secure WWAN carrier's services for a restricted access secure WWAN link to the restricted enterprise corporate resources and trusted IP addresses identified within the restricted access cellular network eSIM credentials. Such restricted access may be established via the restricted access cellular network eSIM that is made available via subscription agreement between a management enterprise and a WWAN service provider to provide a controlled network link or soft gateway via a software layer by the restricted access secure WWAN link. This software layer for a soft gateway may execute via secure user session agent and is the only trusted gateway by an enterprise's restricted corporate resources servers in an embodiment with control of access via the restricted access WWAN carrier.

In an embodiment, the secure user session initiation system 142 and one or more of its parts may communicate with the main memory 104, the EC 140, the processor 102, the video display 110, the alpha-numeric input/output device 112, and the wireless interface device 116 via bus 108, and several forms of communication may be used, including ACPI, SMBus, a 24 MHZ BFSK-coded transmission channel, or shared memory. Driver software, firmware, controllers and the like may communicate with applications on the information handling system 100.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware processing resources executing software or firmware, and hardware implementations.

When referred to as a “system”, a “device,” a “module,” a “controller,” or the like, the embodiments described herein can be configured as hardware or hardware processing resources executing software or firmware code instructions. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a hardware system (such as a motherboard, a system-on-a-chip (SoC), or a stand-alone device). The hardware system, hardware device, hardware controller, or hardware module can include hardware processing resources executing software or firmware embedded at a device, such as an Intel® Core class processor, ARM® brand processors, Qualcomm® Snapdragon processors, an embedded controller (EC) or other processors and chipsets, or other such device, or software capable of operating a relevant environment of the information handling system. The hardware system, hardware device, hardware controller, or hardware module can also include a combination of the foregoing examples of hardware or hardware executing code instructions of software. In an embodiment an information handling system 100 may include an integrated circuit or a board-level product having portions thereof that can also be any combination of hardware and hardware executing code instructions of software. Hardware processing devices, modules, resources, or hardware controllers that are in communication with one another need not be in continuous communication with each other, unless expressly specified otherwise. In addition, hardware processing devices, modules, resources, or hardware controllers, which are in communication with one another can communicate directly or indirectly through one or more intermediaries.

In an embodiment, the IT manager may select an approved restricted access secure WWAN carrier or carriers to subscribe to in anticipation of using the WWAN network for a secure wireless access between the managed client information handling system and secure corporate resources. Further options for selection by the IT manager may include operational configurations and policy settings with respect to operations, security, data and network accesses, and other operational configuration settings for the managed client information handling system. These options may be associated with the identifier information for the managed client information handling system.

The network interface device 116 in an embodiment may use the regular access eSIM credentials 152 to establish a regular access wireless link with the network 120 via a regular access WWAN carrier. In an embodiment, the secure user session agent 144 may detect an unauthorized attempt to access restricted enterprise corporate resources (e.g., located behind a secure enterprise firewall) via such a regular access wireless link. In some embodiments, this may occur when the secure user session agent 144 detects receipt at the wireless interface device 116 of a rejection or blocked access notification from the firewall or corporate resource address. Following detection of such a blocked access attempt, the secure user session agent 144 may transmit a notification of such a blocked access attempt to the IT management server 186, including identification of the managed client information handling system 100, and the secure corporate resource. In some embodiments, such a notification may also include identification of the regular access WWAN network, a location of the managed client information handling system 100, or the regular access eSIM credentials 152.

The IT management server 186, at this point, may identify an appropriate subscribing secure WWAN carrier for providing a secure wireless link to the managed client information handling system 100. For example, the managed client information handling system 100 may determine device location information as determined from a device location sensor 113, such as a global positioning system or a network device locator or other system, included within the notification to the IT management server system of the blocked access attempt to identify and locate the managed client information handling system 100. This device location information data for the managed client information handling system 100 may be used at the remote IT management server to select an optimal restricted access secure WWAN carrier for the physical location of the managed client information handling system 100 in some embodiments herein. In some embodiments, the restricted access secure WWAN carrier may be selected from a list of known subscribing WWAN carriers, which may include the same carrier providing regular access WWAN wireless links using the eSIM credentials 152. In other embodiments, the enterprise may subscribe to separately owned, operated, or maintained WWAN carriers for providing restricted access secure WWAN connections. In some embodiments, such restricted access secure WWAN connections may be facilitated by edge computing gateways owned, operated, and maintained by the enterprise (e.g., via the IT management server 186).

The IT management server 186 in an embodiment may transmit the restricted access cellular network eSIM profile credentials 147 for storage at the eUICC 148 in at least one memory 146 according to an embodiment, following identification of an appropriate secure WWAN carrier for the client information handling system 100. Once the IT manager has selected a specific restricted access secure WWAN carrier or carriers, the manufacturer or IT management may send the reciprocal carrier restricted access cellular network eSIM profile credentials or request for a carrier restricted access cellular network eSIM profile credential directly to a server associated with this restricted access secure WWAN carrier. In an embodiment in which the restricted access cellular network eSIM profile has been pre-loaded at the managed client information handling system 100, the IT management server 186 may transmit an instruction to the managed client information handling system 100 to communicate the stored restricted access cellular network eSIM profile to an identified subscription manager-discovery server (SM-DS) for the restricted access secure WWAN carrier. In an embodiment in which the restricted access cellular network eSIM profile has not been pre-loaded at the managed client information handling system 100, the SM-DS for the restricted access secure WWAN carrier may be prompted to automatically transmit the restricted access cellular network eSIM profile to the managed client information handling system 100.

Upon being operatively coupled to a subscription manager-discovery server (SM-DS) for the restricted access secure WWAN wireless link, the secure user session agent 144 may instruct the user to supply login credentials to be transmitted to an identified enterprise identity server for verification. In an embodiment in which the managed client information handling system 100 transmits verified login credentials to an enterprise identity server in communication with the IT management server 186, the secure user session agent 144 may then establish a secure wireless link with the restricted access secure WWAN carrier using the restricted access cellular network eSIM profile 147. The managed client information handling system 100 in such an embodiment may then transceive data with the secure corporate resources and one or more trusted IP addresses identified within the restricted access cellular network eSIM profile 147 via network 120. This restricted access cellular network eSIM is made available via subscription agreement between a management enterprise and a WWAN service provider to provide a controlled network link or soft gateway via a software layer by the restricted access secure WWAN link. This software layer for a soft gateway may execute via secure user session agent and is the only trusted gateway by an enterprise's restricted corporate resources servers in an embodiment as controlled via the restricted access secure WWAN carrier. In order to further ensure security of the secure WWAN wireless link with the enterprise corporate resources, the secure user session agent in an embodiment may also instruct the wireless interface device 116 to terminate the regular access wireless link established with the regular access WWAN carrier and in some embodiments, other wireless links such as an y WLAN links.

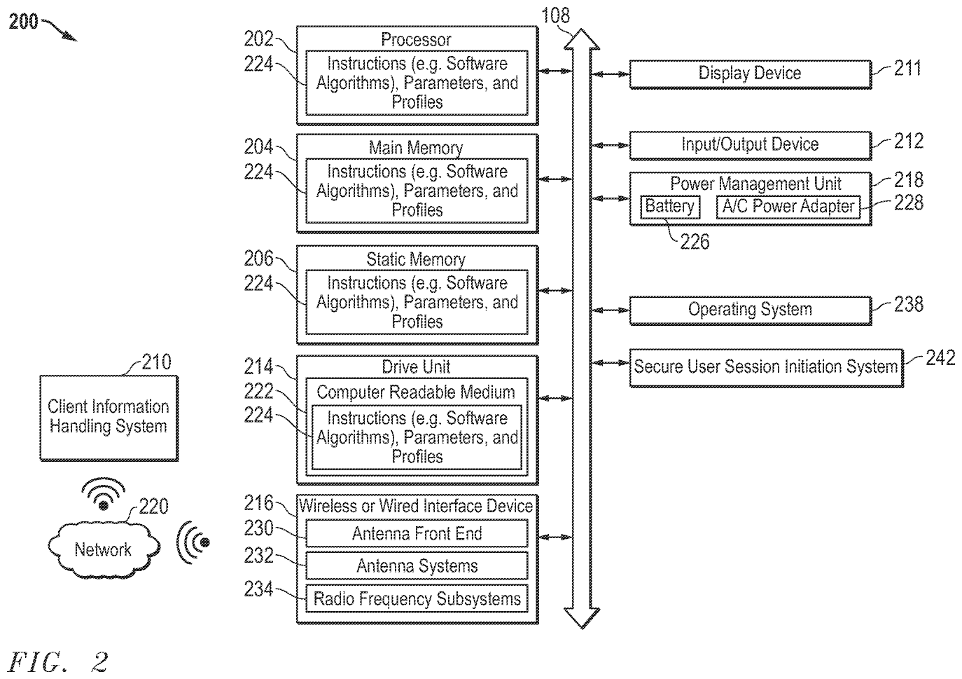

FIG. 2 illustrates an information handling system 200 of an information technology (IT) management server similar to information handling systems according to several aspects of the present disclosure. In example embodiments herein, information handling system 200 may represent any of one or more IT management servers according to embodiments herein. In a networked deployment, the information handling system 200 may operate in the capacity of a server or as a client computer in a server-client network environment, or as a peer computer system in a peer-to-peer (or distributed) network environment. In a particular embodiment, the information handling system 200 can be implemented using electronic devices that provide voice, video or data communication.

The information handling system can include memory (volatile (e.g., random-access memory, etc.), nonvolatile (read-only memory, flash memory etc.) or any combination thereof), one or more hardware processing resources, such as a central processing unit (CPU), a graphics processing unit (GPU), an embedded controller (EC), hardware control logic, a hardware controller or any combination thereof. Additional components of the information handling system 200 can include one or more storage devices, one or more communications ports for communicating with external devices, as well as, various input and output (I/O) devices, such as a keyboard, a mouse, a video/graphic display, or any combination thereof. The information handling system 200 can also include one or more buses operable to transmit communications between the various hardware components. Portions of an information handling system 200 may themselves be considered information handling systems 200.

Information handling system 200 can include devices or modules that embody one or more of the hardware devices or hardware processing resources to execute instructions for the one or more systems and modules described herein, and operates to perform one or more of the methods described herein. The information handling system 200 may execute code instructions 224 that may operate on servers or hardware systems, remote data centers, or on-box in individual client information handling systems according to various embodiments herein. In some embodiments, it is understood any or all portions of code instructions 224 may operate on hardware processing resources at a plurality of information handling systems 200.

The information handling system 200 may include a hardware processor 202 such as a central processing unit (CPU), hardware control logic, hardware controller or some combination of the same. Any of the hardware processing resources may operate to execute code that is either firmware or software code. Moreover, the information handling system 200 can include memory such as main memory 204, or static memory 206. The memory or memory storage with computer readable medium 222 may further include drive unit 214 or static memory 206 (volatile (e.g., random-access memory, etc.), nonvolatile (read-only memory, flash memory etc.) or any combination thereof). The information handling system 200 can also include one or more buses 208 operable to transmit communications between the various hardware components such as any combination of various input and output (I/O) devices.

The information handling system 200 may further include a video display 211. The video display 211 in an embodiment may function as a liquid crystal display (LCD), an organic light emitting diode (OLED), a flat panel display, or a solid-state display. Additionally, the information handling system 200 may include an input/output device 212, such as a cursor control device (e.g., mouse, touchpad, or gesture or touch screen input, and a keyboard. The information handling system 200 can also include a disk drive unit 214. A power management unit 218 supplying power to the information handling system 200, via a battery 226 or an alternating current (A/C) power adapter 228 may supply power to one or more components of the information handling system 200, including the hardware processor 202, or other hardware processing resources executing code instructions of the secure user session initiation system 242, the wireless network interface device 216, a static memory 206 or drive unit 214, a, a video display 211, or other components of an information handling system.

The network interface device, shown as wired or wireless interface device 216 can provide connectivity to a network 220, e.g., a wide area network (WAN), a local area network (LAN), wireless local area network (WLAN), a wireless personal area network (WPAN), a wireless wide area network (WWAN), or other networks. Connectivity may be via wired or wireless connection. Wireless interface device 216 may include one or more radio frequency subsystems 234 with transmitter/receiver circuitry, modem circuitry, one or more radio frequency front end circuits, one or more wireless controller circuits, amplifiers, antenna systems 232 and other radio frequency subsystem circuitry 234 for wireless communications via multiple radio access technologies. These radio access technologies may include Wi-Fi communications, Bluetooth, or near-field communication (NFC) technologies. The wireless interface device 216 may operate in accordance with any wireless data communication standards. To communicate with a wireless local area network, standards including IEEE 802.11 WLAN standards, IEEE 802.15 WPAN standards, WWAN such as 3GPP or 3GPP2, or similar wireless standards may be used. In some aspects of the present disclosure, one wireless interface device 216, also referred to as a network interface device may operate according to two or more WWAN wireless links. In an embodiment, restricted access secure WWAN wireless data communications, for example, may be received and transmitted via the antenna system 232 and antenna front end 230 as described in embodiments of the present disclosure.

The network interface device 216 may operate in accordance with any cellular wireless data communication standards. In embodiments herein, the wireless network interface device 216 may operate with one or more WWAN carriers. For example, the wireless network interface device 216 may operate with one or more WWAN carriers including one or more regular access WWAN carriers or restricted access secure WWAN carriers operating in the physical location of the managed client information handling system 210. The wireless network interface device 216 may operate with a restricted access secure WWAN carrier to which the enterprise subscribes for provisioning of the restricted access cellular network eSIM profile credentials used to establish a second, secure access wireless link via the restricted access secure WWAN carrier for transceiving data between the managed client information handling system 210 and secure corporate resources in an embodiment. In this way, provisioning the restricted access cellular network eSIM credentials maintains and enables use of the second, restricted access secure WWAN at the managed client information handling system 210 in embodiments herein to establish a secure user session for accessing secure corporate resources.

Wireless network interface device 216, in an embodiment, may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WWAN standards, which may operate in both licensed and unlicensed spectrums. More specifically, the network interface device 216 in an embodiment may transceive within radio frequencies associated with the 5G New Radio (NR) Frequency Range 1 (FR1) or Frequency Range 2 (FR2), or those associated with 4G LTE and other standards predating the 5G communications standards now emerging. NRFR1 may include radio frequencies below 6 GHz. NRFR2 may include radio frequencies above 6 GHz, made available within the now emerging 5G communications standard. Communications within the WLAN or WWAN may be enabled through the use of any of a WLAN access point, an evolved Node B (eNodeB) executing an evolved packet core of an existing LTE system, or a Next Generation Node B (gNodeB) executing the next generation packet core of the 5G cellular standard. The wireless interface device 216 may also include radio frequency subsystems 234 circuitry used to connect to any combination of macro-cellular wireless connections including 2G, 2.5G, 3G, 4G, 5G or the like from one or more service providers such as a WWAN service provider for access to wireless network 120.

Utilization of radiofrequency communication bands according to some example embodiments of the present disclosure may include bands used with the WLAN standards and WWAN carriers, which may operate in both licensed and unlicensed spectrums. For example, both WLAN and WWAN may use the Unlicensed National Information Infrastructure (U-NII) band which typically operates in the −5 MHz frequency band such as 802.11 a/h/j/n/ac (e.g., center frequencies between 5.170-5.785 GHz). It is understood that any number of available channels may be available under the 5 GHz shared communication frequency band for WLAN. WLAN, in another example, may also operate at a 2.4 GHz band. WWAN may operate in a number of bands, some of which are proprietary but may include a wireless communication frequency band at approximately 2.5 GHz or 5 GHz bands for example. In additional examples, WWAN carrier licensed bands may operate at frequency bands of approximately 700 MHz, 800 MHz, 1900 MHz, or 1700/2200 MHz as well as the NRFR1, NFRF2, bands, and other known bands.

The present disclosure contemplates a computer-readable medium that includes instructions, parameters, and profiles 224 or receives and executes instructions, parameters, and profiles 224 responsive to a propagated signal, so that a device connected to a network 220 can communicate voice, video or data over the network 220. Further, the code instructions 224 may be transmitted or received over the network 220 via the network interface device or wireless interface device 216.

The information handling system 200 can include a set of code instructions 224 that when executed by hardware processing resources can be executed to cause the computer system to perform any one or more of the methods or computer-based functions disclosed herein. For example, instructions 224 may execute instructions 224 of the secure user session initiation system 242, provisioning of restricted access cellular network eSIM credentials for restricted access secure WWAN link to the managed client information handling system 210 in embodiments herein, software agents, or other software applications, firmware, or other code instructions. Various software modules comprising application code instructions 224 may be coordinated by an operating system (OS) 238, and/or via an application programming interface (API). An example operating system may include Windows®, Android®, and other OS types. Example APIs may include Win 32, Core Java API, or Android APIs.

The disk drive unit 214, or static memory 206 includes a computer-readable medium 222 in which one or more sets of code instructions 224 such as software or firmware can be embedded. Similarly, main memory 204 and static memory 206 may also contain a computer-readable medium for storage of one or more sets of instructions, parameters, or profiles 224. The disk drive unit 214, or static memory 206 may also contain space for data storage. Further, the code instructions 224 may embody one or more of the methods or software systems as described herein. For example, instructions relating to the instructions 224 of the secure user session initiation system 242 for provisioning restricted access cellular network eSIM credentials for restricted access secure WWAN link to a client information handling system 210, other software algorithms, processes, and/or methods may be stored here. In a particular embodiment, the instructions, parameters, and profiles 224 may reside completely, or at least partially, within the main memory 204, or the static memory 206, and/or within the disk drive 214 during execution by the processor 202 of information handling system 200. As explained, some or all of the instructions 224 of the secure user session initiation system 242 for provisioning restricted access cellular network eSIM credentials for restricted access secure WWAN link to a client information handling system 210 may be executed with hardware processing resources locally on an IT management server or servers, SM-DS servers of a carrier, or enterprise identity servers.

Main memory 204 may contain computer-readable medium (not shown), such as RAM in an example embodiment. An example of main memory 204 includes random access memory (RAM) such as static RAM (SRAM), dynamic RAM (DRAM), non-volatile RAM (NV-RAM), or the like, read only memory (ROM), another type of memory, or a combination thereof. Static memory 206 may contain computer-readable medium (not shown), such as NOR or NAND flash memory in some example embodiments. The instructions 224 of the secure user session initiation system 242 for provisioning of restricted access cellular network eSIM credentials to a client information handling system 210 may be stored in memory 204, static memory 206, or the drive unit 214 on a computer-readable medium 222 such as a flash memory or magnetic disk in an example embodiment.

The hardware processor 202 may execute code instructions of the secure user session initiation system 242 to determine one or more trusted internet protocol (IP) addresses, operational configuration settings, identification of one or more enterprise corporate resources (e.g., hardware, software applications, or data stored behind a security firewall of the enterprise) to which the user of the managed client information handling system 210 has been granted access, and other login credentials for the client information handling system 210. These policies and configurations then may be associated with identifier data for the managed client information handling system 210 in memory (e.g., 204, 206, or 214). The secure user session initiation system 242 may instruct a pre-approved or subscribing restricted access secure WWAN carrier to allow a user of the client information handling system 210 to access a secure wireless connection to a secure WWAN network to initiate a secure user sessions for transceiving of data with a secure enterprise corporate resource. The secure user session initiation system 242 may transmit an indication or instruction to the preapproved restricted access secure WWAN carrier that the restricted access cellular network eSIM credentials are to be accepted at the SM-DS and that the enterprise user of the managed client information handling system 210 with a secure user session agent has subscribed to that restricted access secure WWAN carrier's services for a restricted access secure WWAN link to the enterprise corporate resources and trusted IP addresses identified within the restricted access cellular network eSIM credentials.

In an embodiment, the secure user session initiation system 242 and one or more of its parts may communicate with the main memory 204, the processor 202, the video display 211, the alpha-numeric input/output device 212, and the wireless interface device 216 via bus 208, and several forms of communication may be used, including ACPI, SMBus, a 24 MHZ BFSK-coded transmission channel, or shared memory. Driver software, firmware, and the like may communicate with applications on the information handling system 200.

In an embodiment, the information handling system 200 may select an approved restricted access secure WWAN carrier or carriers to subscribe to in anticipation of using the WWAN network for a restricted access secure WWAN link between the managed client information handling system 210 and secure corporate resources. Further options for selection by the information handling system 200 may include operational configurations and policy settings with respect to operations, security, data and network accesses, and other operational configuration settings for the managed client information handling system 210. These options may be associated with the identifier information for the managed client information handling system 210 and stored in memory 204, 206 or 214.

The secure user session initiation system 242 in an embodiment may receive a notification from a secure user session agent of the client information handling system 210 of a blocked access on behalf of the client information handling system 210 to access restricted corporate resources via a regular access WWAN wireless link. Such a notification in an embodiment may include identification of the managed client information handling system 210, and the secure corporate resource. In some embodiments, such a notification may also include identification of the regular access WWAN network, a location of the managed client information handling system 210, or the regular access eSIM credentials.

The information handling system 200, at this point, may identify an appropriate subscribing restricted access secure WWAN carrier for providing a restricted access secure wireless link to the managed client information handling system 210, based in some cases on device location information received from a device location sensor of the client information handling system 210. This device location information data for the managed client information handling system 210 may be used at the information handling system 200 to select an optimal restricted access secure WWAN carrier for the physical location of the managed client information handling system 210 in some embodiments herein. In some embodiments, the restricted access secure WWAN carrier may be selected from a list of known subscribing WWAN carriers, which may include the same carrier providing regular access WWAN wireless links, using the restricted access secure eSIM credentials. In other embodiments, the enterprise may subscribe to separately owned, operated, or maintained WWAN carriers for providing restricted access secure WWAN connections. In some embodiments, such restricted access secure WWAN connections may be facilitated by edge computing gateways owned, operated, and maintained by the enterprise (e.g., via the information handling system 200).

The information handling system 200 in an embodiment may transmit the restricted access cellular network eSIM profile credentials for storage at the eUICC of the client information handling system 210 according to an embodiment, following identification of an appropriate secure WWAN carrier for the client information handling system 210. Once the client information handling system 200 has selected a specific restricted access secure WWAN carrier or carriers, the information handling system 200 may send the reciprocal carrier restricted access cellular network eSIM profile credentials or request for a carrier restricted access cellular network eSIM profile credential to be transmitted directly from a server associated with this restricted access secure WWAN carrier. In an embodiment in which the restricted access cellular network eSIM profile has been pre-loaded at the managed client information handling system 210, the information handling system 200 may transmit an instruction to the managed client information handling system 210 to communicate the stored restricted access cellular network eSIM profile to an identified subscription manager-discovery server (SM-DS) for the restricted access secure WWAN carrier. In an embodiment in which the restricted access cellular network eSIM profile has not been pre-loaded at the managed client information handling system 210, the information handling system 200 may prompt the SM-DS for the restricted access secure WWAN carrier to automatically transmit the restricted access cellular network eSIM profile to the managed client information handling system 210. The restricted access WWAN carrier in an embodiment may then provision and enable restricted access cellular network eSIM credentials for the managed client information handling system 210 in an embodiment. Upon downloading of the restricted access cellular network eSIM credential at the eUICC memory of the managed client information handling system 210, the information handling system 200 may receive indication from the SM-DS for the restricted access secure WWAN carrier that the provisioned restricted access cellular network eSIM credential for the managed client information handling system 210 is enabled with the restricted access secure WWAN carrier.

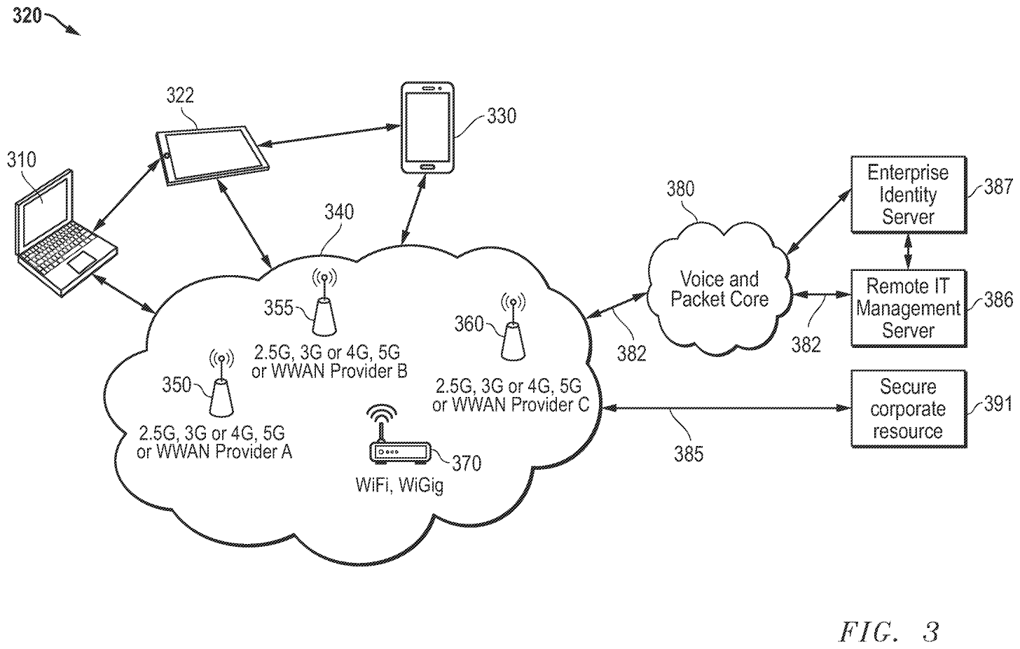

FIG. 3 is a block diagram of a network environment offering several communication protocol options and mobile information handling systems according to an embodiment of the present disclosure. In a particular embodiment, network 320 includes networked information handling systems 310, 322, and 330 that may include one or more managed client information handling systems with wireless capabilities, wireless network access points, and multiple wireless connection link options according to embodiments herein. A variety of additional computing resources of network 320 may include other managed client mobile information handling systems, remote data processing servers such as a remote IT management server or servers, enterprise identity server or servers, network storage devices, local and wide area networks, or other resources as needed or desired. As specifically depicted, managed client information handling systems 310, 322, and 330 may be a laptop computer, tablet computer, 360-degree convertible systems, wearable computing devices, a smart phone device, server systems, or other computing systems. These managed client information handling systems 310, 322, and 330, may access any of a plurality of wireless networks 340. In an example embodiment, these managed client information handling systems 310, 322, or 330 utilize the systems and methods disclosed in embodiments herein for provisioning of restricted access cellular network eSIM credentials for accessing secure corporate resources via a restricted access secure WWAN wireless link. Wireless networks 340 may include WWAN wireless networks 350, 355 and 360 from different WWAN carrier providers. Other communication technologies may include wireless local networks such as 370 including Wi-Fi, WiGig, other WLAN, and small cell WWAN. For example, any of the WWAN wireless networks 350, 355, or 320 may be used as the restricted access secure WWAN carrier for a restricted access secure WWAN link 385 to secure corporate resources 391 located behind an enterprise firewall according to embodiments herein. The IT management server 386 in an embodiment may trigger a regular access WWAN carrier to authorize the managed client information handling system 310 to receive the restricted access secure eSIM profile 147 and eSIM credentials 152 from the same WWAN wireless network or another WWAN wireless network among 350, 355, and 360 according to embodiments herein.

Other communication technologies are described in embodiments herein for wireless communication in some embodiments as well. In other embodiments, wireless networks may include wireless local area networks (WLANs) or small cell systems, a wireless personal area network (WPAN) as between devices such as 310, 320, and 330, or a wireless wide area network (WWAN) such as 350, 355, or 360. In one example embodiment, LTE LPWAN or other WWAN networks may operate with a wireless access point option such as an eNodeB or gNodeB base station or other base station device. In another example embodiment, LTE-LAA WWAN may operate with a small-cell WWAN wireless access point option.

Since WPAN or Wi-Fi Direct Connection and WWAN networks can functionally operate similar to WLANs, they may be considered as wireless local area networks (WLANs) for purposes herein. Components of a WLAN, an LPWAN, or other low power communication technologies may be connected by wireline or Ethernet connections to a wider external network. For example, wireless network access points may be connected to a wireless network controller and an Ethernet switch.

Wireless links within wireless networks 340 of network 320 may include macro-cellular connections via one or more service providers at the macro-cellular network 360. Service provider macro-cellular connections may include 2G standards such as GSM, 2.5G standards such as GSM EDGE and GPRS, 3G standards such as W-CDMA/UMTS and CDMA 2000, 4G standards, or emerging 5G standards including WiMAX, LTE, and LTE Advanced, LTE-LAA, small cell WWAN, and the like. Alternatively, other available wireless communications across any of wireless networks 340 may be via standard protocols such IEEE 802.11 Wi-Fi, IEEE 802.11ad WiGig, IEEE 802.15 WPAN, or other emerging 5G small cell WWAN communications such as eNodeB, or similar wireless network protocols. Wireless networks 340 may include a variety of licensed, unlicensed or shared communication frequency bands as well as a variety of wireless protocol technologies ranging from those operating in macrocells, small cells, picocells, or femtocells. In an embodiment of the present specification, the service providers 360 of the WWAN carriers may operate over licensed bands at frequency bands of approximately 700 MHz, 800 MHz, 1900 MHz, or 1700/2100 MHz for example as well. A network interface device of the networked information handling systems 310, 322, and 330 in an embodiment may transceive within radio frequencies associated with the 5G New Radio (NR) Frequency Range 1 (FR1) or Frequency Range 2 (FR2). NRFR1 may include radio frequencies below 6 GHz, associated with 4G LTE and other standards predating the 5G communications standards now emerging. NRFR2 may include radio frequencies above 6 GHz, made available within the now emerging 5G communications standard. Communications within NRFR1 may be enabled through the use of either an evolved Node B (eNodeB) executing an evolved packet core of an existing LTE system, or a Next Generation Node B (gNodeB) executing the next generation packet core of the 5G cellular standard.

In some embodiments according to the present disclosure, a networked information handling system 310, 320, or 330 may have a plurality of wireless network interface systems capable of transmitting simultaneously within a shared communication frequency band. That communication within a shared communication frequency band may be sourced from different protocols on parallel wireless network interface systems or from a single wireless network interface system capable of transmitting and receiving from multiple protocols. Similarly, in the context of the present specification, the networked information handling systems 310, 322, and 330 may include any number of antennas that may operate to operatively couple the managed client information handling system 310, 322, and 330 to a restricted access secure WWAN carrier SM-DS via a restricted access cellular network eSIM.

In some embodiments, the communications are initiated by an EC loading a driver or drivers associated with the operation of a wireless interface device and associated antenna systems, antenna front ends, and/or radio frequency subsystems with the restricted access cellular network eSIM credentials. The networked information handling systems 310, 322, and 330 may further include an antenna that provides for operatively coupling the networked information handling systems 310, 322, and 330 to the WWAN service providers 350, 355, and 360 operating a using, for example, 5G communication technologies during OS operations after a regular access WWAN eSIM profile is established according to embodiments herein.

The managed client information handling systems 310, 322, and 330 may initially communicate with the approved restricted access secure WWAN carrier SM-DS via a regular access WWAN wireless link in order to initiate provisioning of restricted access cellular network eSIM credentials via the IT management server systems 386 and the restricted access secure WWAN carrier. The IT management server 386 may receive a notification from the secure user session agent at the managed client information handling system 310 that the client information handling system 310 has attempted restricted access to corporate resources via the regular access WWAN wireless link, including identification of the managed client information handling system 310, and the secure corporate resource. In embodiments of the present disclosure, this may trigger the IT management server 386 to transmit an instruction to a selected restricted access secure WWAN carrier (e.g., 360) to provision the client information handling system 310 with a restricted access eSIM credential. A pre-approved or subscribing restricted access secure WWAN carrier (e.g., 360) may be instructed by the IT management server 386, for example, to allow a user to access a restricted access secure wireless connection to a WWAN network to initiate a secure user session for transceiving of data limited to one or more secure enterprise corporate resources or trusted IP sites that are pre-approved. A software layer soft gateway may be established by the secure user session agent via the restricted access secure WWAN carrier with the restricted access eSIM according to embodiments herein. A subscription manager-discovery server (SM-DS) for the restricted access secure WWAN carrier (e.g., 360) may be prompted to automatically transmit a restricted access cellular network eSIM profile to the managed client information handling system 310. In other embodiments, the restricted access cellular network eSIM profile may have been pre-loaded at the managed client information handling system 310 by the IT management server 386 or an IT administrator.

A regular access WWAN wireless link 382 may be established between the selected restricted access secure WWAN carrier base station (e.g., 360) and the managed client information handling system 310 by the selected restricted access secure WWAN SM-DS. With this regular access WWAN wireless link 382, a restricted access cellular network eSIM credential may be downloaded to the eUICC memory at the managed client information handling system 310. Then the provisioned restricted access cellular network eSIM credential for the managed client information handling system 310 may be enabled with the selected restricted access secure WWAN carrier. The restricted access secure WWAN carrier may have been subscribed to by the management enterprise and the restricted access secure WWAN carrier may provide agreed control and limitations via the soft gateway and a software layer to limit access to restricted corporate networked resources or trusted IP sites when using the restricted access secure WWAN link. The limitations via the soft gateway may be coordinated between the secure user session agent at the managed client information handling system 310, 322, or 330, the restricted access secure WWAN carrier 350, 355, or 360, and the secure user session initiation system at the IT management server 386.

The secure user session agent operating at the managed client information handling system 310 may direct an enterprise user at the managed client information handling system 310 to access an identity provider server system and provide enterprise user login credentials or other secure access credentials for authentication of the enterprise user. In this way, enterprise networks, data, and other resources may be protected from unauthorized access. If the managed client information handling system transmits verified login credentials to an enterprise identity server in communication with the IT management server 386, the secure user session agent of the managed client information handling system 310 may then establish a restricted access secure WWAN link 385 with the restricted access secure WWAN carrier using the restricted access cellular network eSIM profile. The managed client information handling system 310 may then transceive data with the secure corporate resources and one or more trusted IP addresses identified within the restricted access cellular network eSIM profile. The endpoint secure user session agent of the managed client information handling system 310 in an embodiment may further terminate the regular access WWAN wireless link at the managed client information handling system, or any WLAN or other wireless links, to inhibit the client information handling system 310 establishing communication with any non-trusted IP addresses.

Wireless networks 340 may be connected through to a voice and packet core network 380 that may contain externally accessible computing resources and connect to a remote data centers such as the remote IT management server 386 or enterprise identity server 387 in network 320. The voice and packet core network 380 may contain multiple intermediate web servers or other locations with accessible data (not shown). The voice and packet core network 380 may also connect to other wireless networks similar to those shown within 340 and additional mobile information handling systems such as 310, 322, 330 or similar connected to those additional wireless networks. Connection 382 between the wireless networks 340 and remote data center 386 or connection to other additional wireless networks may be via Ethernet or another similar connection to the world-wide-web, a WAN, a LAN, another WLAN, or WWAN, or other network structure. Such a connection 382 may be made via a WLAN or WWAN access point/Ethernet switch to the external network and be a backhaul connection. The access point may be connected to one or more wireless access points in the WLAN or WWAN before connecting directly to a mobile information handling system such as 310, 322, 330 or may connect directly to one or more information handling systems 310, 322, and 330. Alternatively, information handling systems 310, 322, and 330 may connect to the external network via base stations according to various wireless protocols 355, 360, or 370 within wireless networks 340. The remote data centers or other remote information handling systems may provide central terminals for IT management and security assessment via operation of always-on management or security solution code instructions via cloud agents of such systems in various embodiments.

Remote data centers such as the remote IT management server systems 386 or the enterprise identity server system 387 may include web servers or resources within a cloud environment that operate via the voice and packet core 380 or other internet connectivity. For example, remote data centers can include additional information handling systems, data processing servers, network storage devices, local and wide area networks, or other resources as needed or desired. In the context of the present specification, the remote data center 386 may include a SM-DS for one or more WWAN carriers 350, 355, or 360 used by the managed client information handling systems such as 310, 322, 330 for restricted and secure WWAN link 385 to the secure corporate resources 391. A remote data center may permit fewer resources to be maintained in other parts of network 320 and may allow the managed client information handling systems such as 310, 322, 330 to operate via a communication in order to download the restricted access eSIM profile to access secure corporate networked resources 391 via the restricted access secure WWAN link 385 as described in embodiments herein.

During operation, an IT manager for the managed information handling systems 310, 322, 330 may access an approved restricted access secure WWAN carrier SM-DS over the plurality of wireless networks 340 in order to provide data related to a subscription to an approved restricted access secure WWAN carrier as well as device identification identifying the managed client information handling systems 310, 322, 330 that may access via a restricted access cellular network eSIM. In the present specification, an EC or other hardware processor of the information handling system 310, 322, 330 executing a secure user session agent may initiate a communication with the approved restricted access secure WWAN carrier SM-DS in order to first verify the identification of the information handling system 310, 322, 330 and then establish a restricted access secure wireless link between the user's information handling system 310, 322, 330 and the secure corporate resources 391 or approved, trusted sites. The restricted access secure eSIM profile may, once downloaded, allow the managed client information handling system 310, 322, 330 to be operatively coupled to a restricted access secure WWAN carrier associated with the service provider at the macro-cellular network 360 to verify login credentials, and then operate with restricted access secure WWAN link 385 limited to pre-approved enterprise networks and data, such as the secure corporate resources 391 or to trusted IP sites.

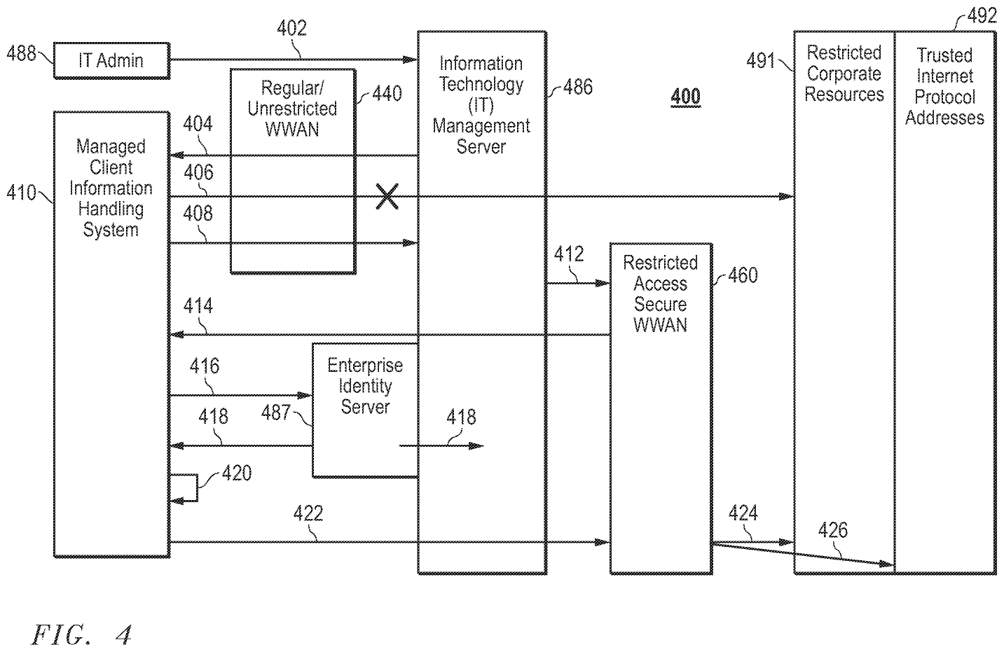

FIG. 4 is a block diagram of a network connecting enterprise managed client information handling systems to secure corporate resources via a restricted access secure wireless wide area network (WWAN) carrier as managed by a secure user session initiation system according to an embodiment of the present disclosure. The network 400 may include an information technology (IT) management server 486 executing instructions of the secure user session initiation system via hardware processing resources to orchestrate access of a managed client information handling system 410 to corporate resources 491 via a secure WWAN carrier 460. The IT management server 486 may receive at 402 configuration policies from an IT administrator 488 including identification of the managed client information handling system 410, a corporate resource 491 to which the managed client information handling system 410 has been granted access, and one or more trusted internet protocol (IP) addresses 492 that are deemed safe to access while accessing the corporate resources 491 or otherwise using the restricted access secure WWAN link.

The IT management server 486 in an embodiment may transmit an instruction 404 via a regular unrestricted WWAN carrier 440 to provide the managed client information handling system with managed client information handling system device security policies for initiating and establishing restricted access secure WWAN links via a restricted access eSIM for storage at the managed client information handling system 410 in one embodiment. Additionally, the IT management server 486 may transmit with the instruction 404 an identification of the restricted access secure WWAN carrier network to use to initiate a secure user session to a secure user session agent at the managed client information handling system 410. The instruction 404 may include with the managed client information handling system device security policies instructions to a secure user session agent at the managed client information handling system to suspend any other networks or network access when establishing a restricted access secure WWAN link is initiated. This may include terminating any other networks or network accesses via other unsecured WWAN or WLAN links for example. This may include prevent or block any network access via any other wireless links in another example.

In embodiments herein, the IT management server 486 may directly store or preload such regular eSIM credentials or restricted access eSIM credentials at the client information handling system 410. In an embodiment, the managed client information handling system 410 may use the unrestricted, regular access eSIM credentials to establish a regular and unsecured wireless link with a network. Via this unsecured network, the managed client information handling system 410 may attempt to access at 406 the secure corporate resources 491, which may be detected by a secure user session agent at the managed client information handling system 410. This attempted access 406 may be blocked by a firewall for the enterprise system based on location, network used, or resources attempted to be accessed. The secure user session agent in an embodiment may then transmit a notification 408 to the IT management server 486 of the blocked or rejected attempt 406 by the managed client information handling system 410 to access the restricted corporate resources 491 via the regular or unrestricted WWAN carrier 440 in an embodiment.

The IT management server 486 in an embodiment may then be triggered to transmit an instruction 412 to a restricted access secure WWAN carrier 460 to provision the managed client information handling system 410 with a restricted access eSIM profile for accessing a restricted access secure WWAN wireless link. In such an embodiment, the restricted access secure WWAN carrier 460 may transmit at 414 the restricted access eSIM credentials and an address for a subscription manager-discovery server (SM-DS) for the restricted access secure WWAN carrier 460 to the managed client information handling system 410. The restricted access secure WWAN carrier 460 may also instruct the SM-DS to grant access for the managed client information handling system 410 to the restricted access secure WWAN network 460 upon confirmation at 416 of login credentials for the managed client information handling system 410 by the enterprise identity server 487. In other embodiments, such a restricted access eSIM profile may already be pre-stored at the managed client information handling system 410. In such an embodiment, the IT management server 486 transmit at 412 the reciprocal received or pre-stored restricted access eSIM credentials to an identified SM-DM of the restricted access secure WWAN 460 if not already there.

A secure user session agent operating at the managed client information handling system 410 may prompt the user to provide login credentials for transmission 416 to the enterprise identity server 487 in an embodiment. Upon acceptance of the login credentials at the enterprise identity server, the IT management server 486 may transmit notification 418 of such approval to the SM-DS for the restricted access secure WWAN carrier 460 and to the managed client information handling system 410. At that point, the restricted access secure WWAN carrier 460 may enable the restricted access cellular network eSIM credentials for the managed client information handling system 410 in an embodiment.

The secure user session agent operating at the managed client information handling system 410 may then terminate the regular WWAN wireless link established with the regular/unrestricted WWAN carrier 440 at 420 in an embodiment. Further, the IT management system may transmit an instruction or may have already transmitted an instruction at 404 with transmitted security policy for the managed client information handling system to suspend any other networks or network access. In an example embedment, the IT management server executing code instructions of the secure user session initiation system may transmit an automatic blocking instruction to the managed client information handling system to block attempts to transceive data with any IP addresses not identified as trusted IP addresses within the restricted access eSIM profile by a secure user session agent executing at the managed client information handling system. In another example, this may include terminating or blocking any other networks or network accesses via other unsecured WWAN or WLAN links. The managed client information handling system 410 in an embodiment may then access corporate resources 491 or trusted internet protocol address 492 identified within the restricted access cellular network eSIM credentials via the restricted access secure WWAN carrier 460 on a restricted access secure WWAN link 422. Access may then be controlled to only access restricted corporate resources 491 via 424 or trusted IP address sites via 426 via the soft gateway as described in embodiments herein.

Further, control of access behind a firewall between 424 and 426 may be further conducted by enterprise edge devices in some embodiments. For example, the restricted access secure WWAN carrier provides limited access for the managed information handling system on the restricted access secure WWAN link via a soft gateway established for the managed client information handling system. This soft gateway operates in a software layer and is the only gateway trusted by an enterprise server. The enterprise server operates as an enterprise system edge gateway provider for access when the soft gateway is established via the restricted access secure WWAN carrier to access the restricted enterprise system corporate resource via 424 or to access the one or more trusted IP addresses for trusted sites.

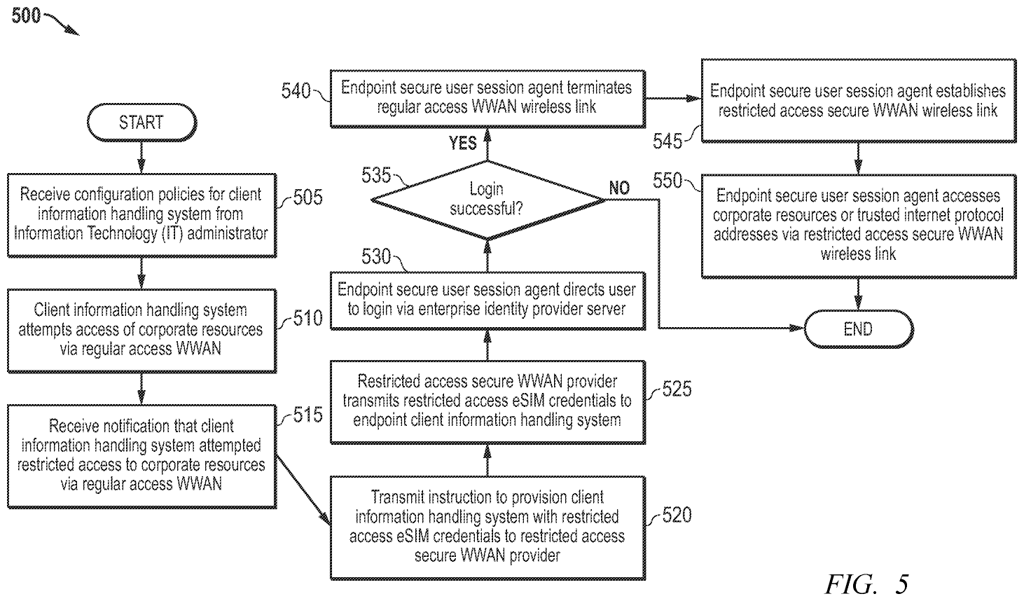

FIG. 5 is a flow diagram of describing a method 500 of establishing a secure user session via a restricted access secure WWAN wireless link for transceiving of data between a managed client information handling system and a secure enterprise corporate resource according to an embodiment of the present disclosure. The method 500 may begin at block 505 with receipt of configuration policies for a managed client information handling system from an information technology (IT) administrator in an embodiment.

An IT manager may determine one or more trusted internet protocol (IP) addresses, operational configuration settings, identification of one or more enterprise corporate resources (e.g., hardware, software applications, or data stored behind a security firewall of the enterprise) to which the user of the client information handling system 100 has been granted access, and other login credentials for the client information handling system. These policies and configurations then may be associated with identifier data for the managed client information handling system 100 at an IT management server 186. The IT management server may transmit several managed client information handling system device security policies to the managed client information handling system for execution by a secure user session agent executing thereon. For example, managed client information handling system device security policies may include identification of one or more approved restricted access secure WWAN carrier for initiating a restricted access secure WWAN link when one is needed. Further, device security policy may include managed client information handling system device security policies may include instructions to a secure user session agent at the managed client information handling system to suspend or terminate any other networks or network access when initiating a restricted access secure WWAN link.

The method may continue at block 510 with the client information handling system attempting access of corporate resources via a regular access WWAN wireless link in an embodiment. For example, in an embodiment described with respect to FIG. 1, the wireless network interface device 116 may operate with one or more WWAN carriers including one or more regular access WWAN carriers operating in the physical location of the managed client information handling system for provisioning of a regular access WWAN eSIM profile 150 on a first, regular access wireless link from the WWAN carrier to the managed client information handling system. The network interface device 116 in an embodiment may use the regular access eSIM credentials 152 to establish a regular access wireless link with the network 120 via a regular access WWAN carrier. In an embodiment, the secure user session agent 144 may detect an unauthorized attempt to access restricted enterprise corporate resources (e.g., located behind a secure enterprise firewall) via such a regular access wireless link. In some embodiments, this may occur when the secure user session agent 144 detects receipt at the wireless interface device 116 of a rejection or blocked access notification from the firewall or corporate resource address.

At block 515, the IT management server in an embodiment may receive a notification that the client information handling system has attempted restricted access to corporate resources via the regular access WWAN wireless link. For example, following detection of a blocked access attempt, the secure user session agent 144 may transmit a notification of such a blocked access attempt to the IT management server 186, including identification of the managed client information handling system 100, and the secure corporate resource. In some embodiments, such a notification may also include identification of the regular access WWAN network, a location of the managed client information handling system 100, or the regular access eSIM credentials 152.

The IT management server in an embodiment at block 520 may transmit an instruction to a selected restricted access secure WWAN carrier to provision the client information handling system with a restricted access eSIM credential. A pre-approved or subscribing restricted access secure WWAN carrier may be instructed by the IT management server 186 in an embodiment to allow a user to, via the wireless interface device 116, access a secure wireless connection to a WWAN network 120 to initiate a secure user session for transceiving of data with a restricted enterprise corporate resource. The preapproved restricted access secure WWAN carrier may receive indication that the restricted access cellular network eSIM credentials 147 are to be accepted at the SM-DS and that the enterprise user has subscribed to that restricted access secure WWAN carrier's services for a restricted access secure WWAN link to the enterprise corporate resources and trusted IP addresses identified within the restricted access cellular network eSIM credentials or otherwise to the restricted access WWAN carrier such that a soft gateway is established to prohibit accesses outside of the enterprise corporate resources and trusted IP addresses identified by the managed client information handling system.

The IT management server 186 may transmit a request to a selected secure WWAN carrier for a carrier restricted access cellular network eSIM profile credential to be transmitted directly from the subscription manager-discovery server (SM-DS) for the restricted access secure WWAN carrier to the client information handling system 100 via the regular access WWAN wireless link already established via the network interface device 116. The SM-DS for the restricted access secure WWAN carrier may be prompted to automatically transmit the restricted access cellular network eSIM profile to the managed client information handling system 100. In other embodiments, the restricted access cellular network eSIM profile may have been pre-loaded at the managed client information handling system 100 by the IT management server 186 or an IT administrator. In such an embodiment, the IT management server 186 may communicate that the stored restricted access cellular network eSIM profile is approved to the SM-DS for the restricted access secure WWAN carrier.

The IT management server 186, may identify an appropriate subscribing restricted access secure WWAN carrier for providing a restricted access secure wireless link to the managed client information handling system 100, based on a determined device location information, included within the notification to the IT management server system of the blocked access attempt (e.g., as described above with respect to block 515). This device location information data for the managed client information handling system 100 may be used at the remote IT management server to select an optimal restricted access secure WWAN carrier for the physical location of the managed client information handling system 100 in some embodiments herein. In some embodiments, the restricted access secure WWAN carrier may be selected from a list of known or approved subscribing WWAN carriers, which may include the same carrier providing regular access WWAN wireless links using the eSIM credentials 152. In other embodiments, the enterprise may subscribe to separately owned, operated, or maintained WWAN carriers for providing restricted access secure WWAN connections. In some embodiments, such restricted access secure WWAN connections may be facilitated by edge computing gateways owned, operated, and maintained by the enterprise (e.g., via the IT management server 186).

The restricted access WWAN carrier in an embodiment may transmit a restricted access eSIM credential to the client information handling system at block 525. The WWAN carrier may provision and enable restricted access cellular network eSIM credentials 147 for the managed client information handling system 100 in an embodiment. A regular access WWAN wireless link is established between the selected restricted access secure WWAN carrier base station and the managed client information handling system 100 by the selected restricted access secure WWAN SM-DS. With this regular access WWAN wireless link, a restricted access cellular network eSIM credential 147 is downloaded to the eUICC memory 148 at the managed client information handling system 100. Then the provisioned restricted access cellular network eSIM credential 147 for the managed client information handling system 100 is enabled with the WWAN carrier. The WWAN carrier may also notify the IT management server 186 that the managed client information handling system 100 is successfully provisioned with the restricted access cellular network eSIM credential 147.

At block 530, the secure user session agent may direct an enterprise user at the managed client information handling system to access an identity provider server system and provide enterprise user login credentials or other secure access credentials for authentication of the enterprise user. In this way, enterprise networks, data, and other resources may be protected from unauthorized access. This includes unauthorized downloads of designated software or firmware or other firewalled corporate resources.

At block 535, the enterprise user login credentials or other secure access credentials are validated by the enterprise identity provider service server. If not successfully authenticated at block 560, the method may end, and a notification of the unsuccessful attempt to establish a secure WWAN wireless link may be provided to the IT management server. If the login or other secure credentials of the enterprise user are successfully authenticated at block 535, the method may proceed to block 540.

At block 540, the endpoint secure user session agent in an embodiment may terminate the regular access WWAN wireless link. For example, the secure user session agent in an embodiment may instruct the wireless interface device 116 to terminate the regular access wireless link established with the regular access WWAN carrier. Further, the secure user session agent in an embodiment may terminate other unsecure wireless links such as any WLAN wireless links. This may inhibit the client information handling system 100 or any remote device to attempt to establish communication with any non-trusted IP addresses.

The endpoint user session agent in an embodiment may establish a restricted access secure WWAN wireless link at block 545. For example, in an embodiment in which the managed client information handling system 100 transmits verified login credentials to an enterprise identity server in communication with the IT management server 186, the secure user session agent 144 may then establish a restricted access secure wireless link with the restricted access secure WWAN carrier using the restricted access cellular network eSIM profile 147. The managed client information handling system 100 in such an embodiment may then transceive data with the secure corporate resources and one or more trusted IP addresses identified within the restricted access cellular network eSIM profile 147 via network 120 at block 550. In such a way, the secure user session initiation system operating at an IT management server, in tandem with an agent operating at each managed client information handling system in an embodiment, may automatically provision managed client information handling systems with eSIM credentials for accessing a secure WWAN that only grants access of the authorized managed client information handling system to enterprise corporate resources and trusted IP addresses. At this point, the method may end.

The blocks of the flow diagrams of FIG. 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A method of initiating a secure user session for a managed client information handling system through a restricted access secure wireless wide area network (WWAN), comprising:
executing code instructions, via hardware processing resources at an information technology (IT) management server, of a secure user session initiation system to secure access to an enterprise system corporate resource or to trusted internet protocol addresses and limit other network accesses for a managed client information handling system;
receiving, at a network interface device of the IT management server, security configuration settings for the managed client information handling system including an address of an enterprise identity provider, authorization to access an enterprise system corporate resource, and identification of a trusted internet protocol address;
transmitting, via the network interface device, client information handling system security policies to a secure user session agent at the managed client information handling system identifying a selected restricted access secure WWAN carrier to use to initiate a secure user session on a restricted access secure WWAN link; and
transmitting a secure access provisioning instruction to the restricted access secure WWAN carrier for provisioning of a restricted access eSIM profile to the managed client information handling system limiting the restricted access secure WWAN wireless link established to transceive data between the managed client information handling system and the enterprise system corporate resource or trusted internet protocol address identified within the restricted access eSIM profile.

2. The method of claim 1, wherein a regular access WWAN carrier is utilized transmit client information handling system security policies and to provision the restricted access eSIM profile to the managed client information handling system.

3. The method of claim 1 further comprising:
identifying the restricted access secure WWAN carrier from a list of subscribing secure WWAN carriers and selecting one based on location of the managed client information handling system.

4. The method of claim 1, wherein the restricted access secure WWAN carrier provides limited access for the managed information handling system on the restricted access secure WWAN link via a soft gateway established for the managed client information handling system and only such a soft gateway in a software layer is trusted by an enterprise server operating as an enterprise system edge gateway provider with the enterprise system corporate resource.

5. The method of claim 1 further comprising:
transmitting a login requirement instruction to the managed client information handling system restricting access to the restricted access eSIM profile by a secure user session agent executing at the managed client information handling system until a login verification instruction has been received from an enterprise identity server.

6. The method of claim 1 further comprising:
receiving a notification of attempted unauthorized access to secure enterprise system resources from the managed client information handling system to trigger establishment of the restricted access WWAN wireless link for the managed client information handling system.

7. The method of claim 1 further comprising:
transmitting an automatic blocking instruction to the managed client information handling system to block attempts to transceive data with any IP addresses not identified as trusted IP addresses within the restricted access eSIM profile by a secure user session agent executing at the managed client information handling system.

8. An information technology (IT) management server information handling system executing code instructions of a secure user session initiation system, comprising:
a hardware processor receiving, via a network interface, security configuration settings for a managed client information handling system from an IT administrator, including an address of an enterprise identity provider, authorization to access an enterprise system corporate resource, and identification of a trusted internet protocol address;
the network interface device to receive a notification of attempted unauthorized access to secure enterprise system resources from a secure user session agent of a managed client information handling system via a first regular access WWAN wireless link; and
the hardware processor transmitting, via the network interface device, a first provisioning instruction to a second subscribing restricted access secure WWAN carrier for provisioning of a restricted access eSIM profile to the managed client information handling system limiting a restricted access secure WWAN wireless link on the second subscribing restricted access secure WWAN carrier, where the restricted access secure WWAN wireless link is established to limit transceiving data between the client information handling system and the enterprise system corporate resource or trusted internet protocol address and to exclude other network accesses at the managed client information handling system; and
the network interface device transmitting an instruction including a managed client information handling system security policy for the secure user session agent to suspend or terminate all other network links at the managed client information handling system upon initiation of a restricted access secure WWAN link.

9. The IT management server information handling system of claim 8, wherein enterprise corporate resources include IP addresses located behind an enterprise firewall.

10. The IT management server information handling system of claim 8 further comprising:
the hardware processor determining the restricted access secure WWAN wireless link from a subscribing restricted access secure WWAN carrier with a pre-established subscription to operate the restricted access secure WWAN wireless link with limited access to the enterprise system corporate resource or trusted internet protocol address per the restricted access eSIM.

11. The IT management server information handling system of claim 8, wherein the restricted access secure WWAN carrier provides limited access for the managed information handling system on the restricted access secure WWAN link via a soft gateway established for the managed client information handling system and only such a soft gateway in a software layer is trusted by an enterprise server operating as an enterprise system edge gateway provider with the enterprise system corporate resource.

12. The IT management server information handling system of claim 8 further comprising:
the network interface device transmitting a login requirement instruction to the managed client information handling system and restricting access to the restricted access secure WWAN link by a secure user session agent executing at the managed client information handling system until a login verification instruction has been received from an enterprise identity server.

13. The IT management server information handling system of claim 8 further comprising:
the network interface device transmitting an automatic blocking instruction to the managed client information handling system to block attempts to transceive data with IP addresses not identified as trusted IP addresses within the restricted access eSIM profile by a secure user session agent executing at the managed client information handling system.

14. A managed client information handling system operating a secure user session initiation system comprising:
a hardware processor, an embedded controller (EC), a memory, and a network interface device;
an electronic subscriber identity module (eSIM) memory storing a first, regular access eSIM installed with a regular access profile to access a first regular access wireless wide area network (WWAN) link;
the hardware processor executing code instructions of the secure user session agent to detect a blocked, unauthorized attempt by the managed client information handling system to access secure enterprise system corporate resources via the first regular access WWAN link;
the hardware processor executing code instructions of the secure user session agent to transmit notification of the unauthorized attempt to a remote information technology (IT) management server executing code instructions of a secure user session initiation system;
an embedded universal integrated circuit card (eUICC) receiving, via the network interface device, a restricted access eSIM profile limiting a second restricted access secure WWAN link to transceive data between the managed client information handling system and the enterprise system corporate resource or trusted internet protocol address;
the hardware processor executing code instructions of the secure user session initiation system to automatically establish, via the network interface device, the second restricted access secure WWAN link with a subscribing secure WWAN carrier using the restricted access eSIM;
the hardware processor executing code instructions of the secure user session agent to automatically terminate the first regular access WWAN link; and
the network interface device to transceive data, via the second restricted access secure WWAN link between the managed client information handling system and limited to the enterprise system corporate resource or the trusted internet protocol address determined for the managed client information handling system.

15. The managed client information handling system of claim 14, wherein the restricted access secure WWAN carrier provides limited access for the managed information handling system on the restricted access secure WWAN link via a soft gateway established by the secure user session agent at the managed client information handling system and only such a soft gateway in a software layer is trusted by an enterprise server operating as an enterprise system edge gateway provider with the restricted enterprise system corporate resource and the trusted IP address.

16. The managed client information handling system of claim 14, wherein the hardware processor executing code instructions of the secure user session agent receives a managed client information handling system security policy for the secure user session agent to suspend or terminate all other network links at the managed client information handling system upon initiation of a restricted access secure WWAN link.

17. The managed client information handling system of claim 14 further comprising:
the hardware processor executing code instructions of the secure user session agent to block an attempt to access a non-trusted IP address via any wireless link at the managed client information handling system.

18. The managed client information handling system of claim 14 further comprising:
the hardware processor executing code instructions of the secure user session agent to transmit verified login credentials to an enterprise identity server to permit access to the restricted enterprise system corporate resource or the trusted internet protocol address determined for the managed client information handling system via the restricted access secure WWAN link.

19. The managed client information handling system of claim 14 further comprising:
the network interface device receiving an address for an enterprise identity provider for transmission of verified login credentials for the managed client information handling system.

20. The managed client information handling system of claim 14, wherein restricted enterprise corporate resources include plural trusted IP addresses located behind an enterprise firewall.
